(19) United States
(12) Patent Application Publication
(10) Pub. No.: US 2018/0290578 A1
(43) Pub. Date: Oct. 11, 2018

(54) MOTOR VEHICLE REST PEDAL AND BRACKET FOR THE SAME

(71) Applicant: NIO CO., LTD., Shanghai (CN)

(72) Inventors: Bao RONG, Shanghai (CN); Hong YAN, Shanghai (CN); Jia LI, Shanghai (CN); Liwen LV, Shanghai (CN); Yanqing WEN, Shanghai (CN)

(21) Appl. No.: 15/949,279

(22) Filed: Apr. 10, 2018

(30) Foreign Application Priority Data
Apr. 10, 2017 (CN) 201720364687.6

(51) Int. Cl. B60N 3/06; F16M 13/02

(52) U.S. Cl. CPC B60N 3/06; F16M 13/02

(57) ABSTRACT

The present application relates to accessories of motor vehicle, particularly to a bracket for motor vehicle rest pedal and rest pedal. The present application aims at solving the problem that existing motor vehicle rest pedals are prone to deforming and breaking. To this end, the bracket comprises a first bracket part secured within the vehicle and a second bracket part connected to the first bracket part and used for fixing the pedal plate. The second bracket part is of L-like plate structure such that a part of the second bracket part extends under the fixed pedal plate and supports the same. The structural stiffness and rigidity of the rest pedal is strengthened by the L-like plate structure of the second bracket part of the bracket of the present application to prohibit deformation of the rest pedal due to bad road condition or emergency braking.

### CROSS-REFERENCE TO RELATED APPLICATION

This application claims the benefit of China Patent Application No. 201720364687.6 filed Apr. 10, 2017, the entire contents of which are incorporated herein by reference in its entirety.

### TECHNICAL FIELD

The present application relates to accessories of motor vehicle, particularly to a motor vehicle rest pedal and bracket for the same.

### BACKGROUND

The instrument panels of luxurious vehicles are provided with co-driver rest pedals, on which occupants on co-driver seats could put their feet to gain an enhanced riding experience. During research and development, a co-driver rest pedal system of a vehicle is connected to the vehicle body through the bracket of the rest pedal, the stiffness and rigidity of which bracket is an important factor influencing performance of the rest pedal system and directly impacts reliability of the rest pedal system in use. The co-driver rest pedal of a vehicle is used to support tread force of occupants, which exert extremely great force in case of bad road condition and emergency braking. Therefore, it should be ensured that the co-driver rest pedal of a vehicle possesses sufficient stiffness and rigidity to work safely under various harsh tread conditions. Insufficient bracket stiffness and rigidity of the co-driver rest pedal results in such potential hazards as swaying and shaking upon treading and even leads to breaking pedal in extreme situations.

Currently, the bracket of a co-driver rest pedal of a vehicle is merely connected with the pedal side facing away from the seat; the contact area of them is rather small, leading to insufficient stiffness and rigidity of the whole rest pedal. Thus, the rest pedal is prone to swaying and shaking upon co-driver's treading and deformed or even broken under bad road conditions.

### SUMMARY

To solve the above problems in the art, on one hand, the present application provides a bracket for motor vehicle rest pedal, which considerably improves structural stiffness and rigidity of the pedal system of motor vehicle, reduces the risk that the bracket might deform or break in case of bad road condition or emergency braking, enhancing riding comfort of occupants. On the other hand, the present application provides a motor vehicle rest pedal.

To achieve previously stated end, according to one aspect of the application, the application provides a bracket for motor vehicle rest pedal, which comprises a first bracket part secured within the motor vehicle and a second bracket part connected to the first bracket part and used for fixing a pedal plate, wherein the second bracket part is of L-like plate structure such that a portion of the second bracket part extends under the fixed pedal plate and supports the same.

In a preferable embodiment of the above bracket, the second bracket part can be rotated by a preset angle relative to the first bracket part.

In a preferable embodiment of the above bracket, the first and second bracket parts are respectively provided with at least one pin connecting hole and rotatably connected with one another by pin.

In a preferable embodiment of the above bracket, one of the first and second bracket parts is connected with the pin without relative rotation and the other is rotatable relative to the pin.

In a preferable embodiment of the above bracket, internal wall of each pin connecting hole of the first bracket part and outer surface of the pin are respectively provided with a groove and a projection mating with each other such that there is no relative rotation between the pin and the first bracket part; or internal wall of each pin connecting hole of the second bracket part and outer surface of the pin are respectively provided with a groove and a projection mating with each other such that there is no relative rotation between the pin and the second bracket part.

In a preferable embodiment of the above bracket, the bracket further includes a stopper, by means of which the rotation angle of the second bracket part is limited.

In a preferable embodiment of the above bracket, the L-like plate structure is provided with at least one reinforce rib and/or at least one weight reduction hole.

In a preferable embodiment of the above bracket, the second bracket part is of single piece structure or multi-piece structure consisting of more than one piece arranged side by side in axial direction of the pin.

In a preferable embodiment of the above bracket, the structure and shape of the second bracket part match those of the pedal plate.

In a preferable embodiment of the above bracket, the bracket is a bracket for co-driver motor vehicle rest pedal.

According to another aspect of the application, the application also provides a motor vehicle rest pedal, wherein the rest pedal comprises a bracket as set forth in any one of claims 1 to 10, and wherein a pedal plate is fixed on the second bracket part.

Beneficial Effects

In the previously mentioned embodiments, the bracket for motor vehicle rest pedal has the first bracket part and the second bracket part which is of L-like plate structure and supports the pedal plate thereon to enhance the structural stiffness and rigidity of the whole rest pedal. Accordingly, swaying and shaking is avoided when users tread on the pedal, drastically decreasing the maximum displacement of the pedal caused by bad road condition or emergency braking and lowering down the risk that the pedal plate is severely deformed or even broken. As a result, the rest pedal and its bracket are much more reliable than those traditional ones.

### BRIEF DESCRIPTION OF DRAWINGS

FIG. 1 is a schematic illustration of a co-driver rest pedal of a motor vehicle in one embodiment of the application;

FIG. 2 is a structural schematic illustration of the first bracket part of the co-driver rest pedal of a motor vehicle in the embodiment shown in FIG. 1;

FIG. 3 is a structural schematic illustration of the second bracket part of the co-driver rest pedal of a motor vehicle in the embodiment shown in FIG. 1;

FIG. 4 is a side view of the first bracket part shown in FIG. 2;

FIG. 5 is a structural schematic illustration of the pin of the co-driver rest pedal of a motor vehicle in one embodiment; and

FIG. 6 is a close-up side view of the pin in the embodiment shown in FIG. 5.

### DETAILED DESCRIPTION

Various preferred embodiments, features and aspects of the present application will be described below with reference to the accompanying figures. The same reference numbers are used to indicate the same elements with same or similar functions in the drawings. The term “illustrative” used herein means exemplary, descriptive or explanatory. Any currently described illustrative embodiments do not necessarily have to be superior to or better than other embodiments. Additionally, many specific details are given in the specific embodiments described below, in order that the present application is better explained. However, it should be understood by those skilled in the art that the application could be carried out without some specific details. In some embodiments, those methods, means and elements well known to those skilled in the art will not be detailed herein so as to highlight the core principle of the disclosure. As can be understood by those skilled in the art, these embodiments are merely intended for purpose of interpreting the technical principle of the application, rather than limiting its protect scope.

Generally, the basic idea of the application is to divide the bracket for motor vehicle rest pedal into two or more pieces, the second bracket part is of L-like plate structure, which is used for fixing the pedal plate and a portion of which extends under the pedal plate and supports the same to increase the structural stiffness and rigidity of the whole rest pedal.

The application is detailed by way of a co-driver motor vehicle rest pedal. Of course, it is not limited to a co-driver rest pedal, instead it can also be a rest pedal for a back row occupants.

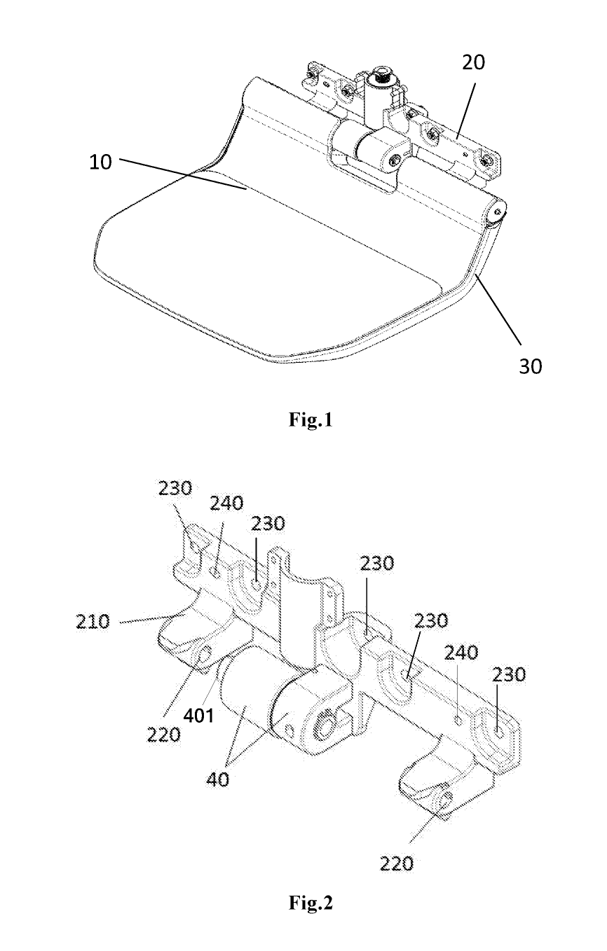

FIG. 1 is a schematic illustration of a co-driver motor vehicle rest pedal in one embodiment of the application. In the embodiment, the rest pedal includes a pedal plate 10, a first bracket part 20 and a second bracket part 30. The second bracket part 30 is rotatably connected to the first bracket part 20, which can be secured onto the interior side of the instrumental panel of motor vehicle. Moreover, the second bracket part 30 is of L-like plate structure and extends under and thus supports the pedal plate 10 fixed on the second bracket part 30. By extending under and supporting a large area of the pedal plate 10, the second bracket part 30 strengthens the structural stiffness and rigidity of the pedal plate to prevent the pedal plate from swaying and shaking upon being trodden, greatly reducing the maximum displacement of the pedal plate caused by bad road condition and emergency braking and lowering down the risk that the pedal plate is severely deformed or even broken.

FIG. 2 is a structural schematic illustration of the first bracket part 20 of the co-driver motor vehicle rest pedal in the embodiment shown in FIG. 1. In FIG. 2, the first bracket part 20 includes a bracket body 210, two pin connecting holes 220, several bolt connecting holes 230 and more than one positioning holes 240. The body 210 of the first bracket part 20 is secured onto the instrument panel by the bolt connecting holes 230 and the positioning holes 240. The first bracket part 20 is also provided with a stopper 40, by means of which the rotation angle of the second bracket part 30 relative to the first bracket part 20 is limited. For example, the second bracket part 30 is limited as basically parallel to the floor of the motor vehicle at its maximum angle. In another embodiment, the stopper 40 could be installed onto the second bracket part 30.

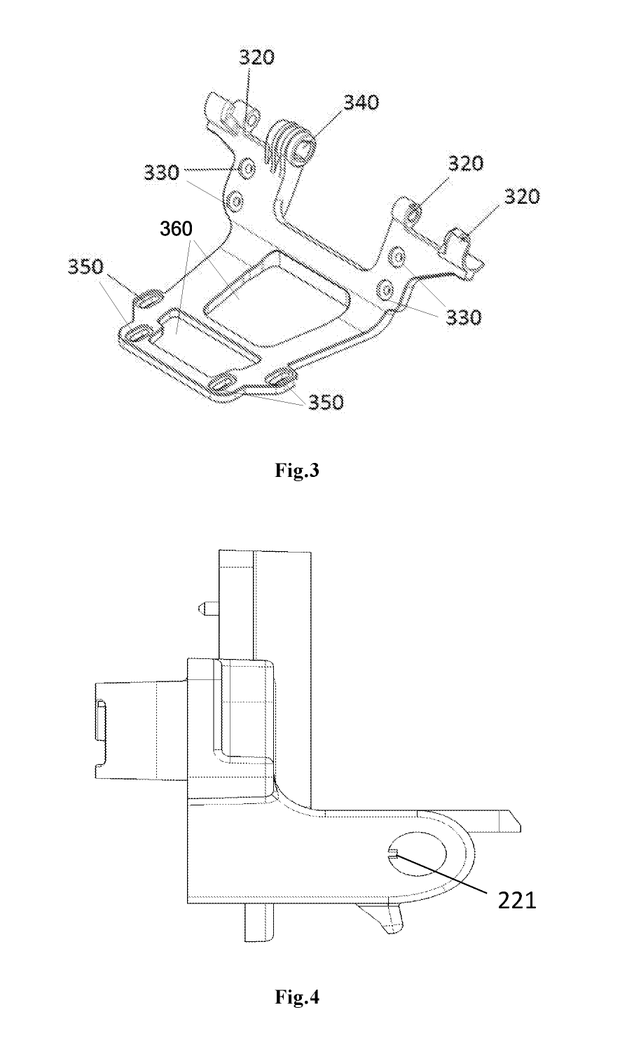

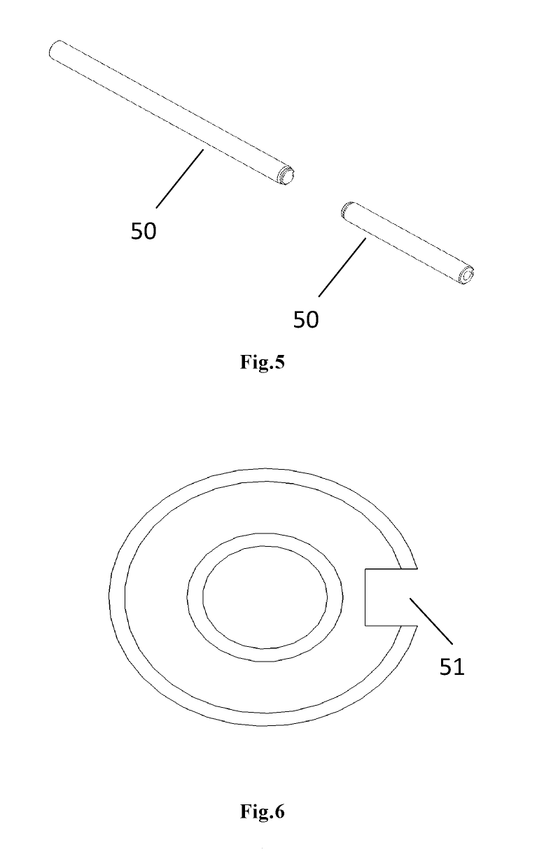

FIG. 3 is a structural schematic illustration of the second bracket part 30 of the co-driver rest pedal of a motor vehicle in the embodiment shown in FIG. 1. In FIG. 3, the second bracket part 30 includes three pin connecting holes 320, a stopper connecting hole 340, several bolt connecting holes 330 and more than one kidney-shape connecting holes 350. In assembled state, a pin 50 (see FIG. 5) passes through the pin connecting holes 220 of the first bracket part 20 and the pin connecting holes 320 of the second bracket part 30 to rotatably connect the second bracket part 30 with the first bracket part 20. The stopper connecting hole 340 is elongated in shape, the output shaft 401 of the stopper 40 has a shape mating with that of the stopper connecting hole 340 and is inserted into the stopper connecting hole 340 without relative rotation in assembled state. By rotating the second bracket part 30 relative to the first bracket part 20, the second bracket part 30 as well as the pedal plate 10 can be retracted to save space when they are not to be used and can be rotated back to their working positions when they are to be used. The second bracket part 30 and the pedal plate 10 are bolted together by means of the bolt connecting holes 330 and the kidney-shape connecting holes 350. By providing kidney-shape connecting holes 350, low installment efficiency due to design tolerance could be obviated. As should be understood by those skilled in the art, the connecting area and the number of connecting holes of the second bracket part 30 and the pedal plate 10 vary according to the form of the co-driver rest pedal. As shown in FIG. 3, the second bracket part 30 is also provided with weight reduction holes 360 to reduce the weight of the pedal plate and save material. Further, according to specific applications, the second bracket part 30 can also be provided with support ribs (not shown in figures), with aid of which the stiffness and rigidity of the pedal plate is guaranteed while its thickness is kept small.

FIG. 4 is a side view of the first bracket part 20 shown in FIG. 2. As shown in FIG. 4, the internal wall of each pin connecting hole 220 of the first bracket part 20 is provided with a projection 221, and the outer surface of the pin 50 is provided with a groove 51(see FIG. 6) mating with a respective projection 221. When the pin 50 is inserted into the pin connecting hole 220 of the first bracket part 20, the projection 221 is fitted into the groove 51 to prevent the pin 50 from rotating relative to the first bracket part 20. The internal wall of each pin connecting hole 320 is not provided with any projection, so that the pin 50 is able to rotate relative the second bracket part 30 in assembled state. In another embodiment, the pin 50 can designed as fixed relative to the second bracket part 30 and rotatable relative to the first bracket part 20. Specifically, the internal wall of each pin connecting 320 of the second bracket part 30 and the outer surface of the pin 50 are respectively provided with a groove and a projection mating with each other such that there is no relative rotation between the pin 50 and the second bracket part 30. Meanwhile, the internal wall of each pin connecting hole 220 of the first bracket part 20 is provided with no projection in order that the pin 50 is able to rotate relative to the first bracket part 20 in assembled state. By connecting one of the first bracket part 20 and the second bracket part 30 with the pin 50 without relative rotation between them and rotatably connecting the other bracket with the pin 50, on one hand the relative rotation between the second bracket part 30 and the first bracket part 20 is easily realized, and on the other hand the pin 50 is prevented from easily slipping out of the pin connecting holes 220 and 320 so as to ensure the connecting reliability.

FIG. 5 and FIG. 6 show structures of the pin of the co-driver rest pedal in one embodiment of the present application. As shown in FIG. 5, the pin 50 consists of two sections, which are able to be inserted into the pin connecting holes 220 and 320 respectively from left and right sides shown in FIG. 1, connecting the first bracket part 20 and the second bracket part 30 together. As shown in FIG. 6, the outer surface of the pin 50 is provided with a groove 51, which as described above mates with projection within the pin connecting hole 220 of the first bracket part 20 and the pin connecting hole 320 of the second bracket part 30, thus preventing the pin 50 from rotating relative to the first bracket part 20 or the second bracket part 30. In another embodiment, it is also possible to provide a projection on the outer surface of the pin 50, accordingly the internal wall of the pin connecting hole of the first bracket part 20 or the second bracket part 30 is provided with a respective groove.

In the previously mentioned embodiments, the bracket for motor vehicle rest pedal has the first bracket part and the second bracket part which is of L-like plate structure and supports the pedal plate thereon to enhance the structural stiffness and rigidity of the whole rest pedal. Accordingly, swaying and shaking is avoided when users tread on the pedal, drastically decreasing the maximum displacement of the pedal caused by bad road condition or emergency braking and lowering down the risk that the pedal plate is severely deformed or even broken. As a result, the rest pedal and its bracket are much more reliable than those traditional ones.

It should be noted that the terms “first” and “second” in this application are used for distinguishing one object from other similar ones rather than describing or indicating any specific or sequential order.

The term “comprise” or other similar terms in this application mean non-exclusively containing, such that the process, article or equipment/device comprising a series of factors also includes other factors not expressly listed or all inherent factors of the process, article or equipment/device.

So far the technical solutions of the present application have been described with reference to the preferred embodiments shown in the accompanying figures. However, as will be appreciated by those skilled in the art, these specific embodiments are not intended to limit protection scope of the application. It will be understood by those skilled in the art that without departing from the principle of the application, various changes may be made and equivalents may be substituted for related technical features, the varied or substituted technical solutions will fall within protection scope of the application.

What is claimed is:

1. A bracket for motor vehicle rest pedal, comprising a first bracket part secured within the motor vehicle and a second bracket part connected to the first bracket part and used for fixing a pedal plate, wherein the second bracket part is of L-like plate structure such that a portion of the second bracket part extends under the fixed pedal plate and supports the same.

2. The bracket for motor vehicle rest pedal as set forth in claim 1, wherein the second bracket part can be rotated by a preset angle relative to the first bracket part.

3. The bracket for motor vehicle rest pedal as set forth in claim 2, wherein the first and second bracket parts are respectively provided with at least one pin connecting hole and rotatably connected with one another by pin.

4. The bracket for motor vehicle rest pedal as set forth in claim 3, wherein one of the first and second bracket parts is connected with the pin without relative rotation and the other is rotatable relative to the pin.

5. The bracket for motor vehicle rest pedal as set forth in claim 4, wherein internal wall of each pin connecting hole of the first bracket part and outer surface of the pin are respectively provided with a groove and a projection mating with each other such that there is no relative rotation between the pin and the first bracket part; or
internal wall of each pin connecting hole of the second bracket part and outer surface of the pin are respectively provided with a groove and a projection mating with each other such that there is no relative rotation between the pin and the second bracket part.

6. The bracket for motor vehicle rest pedal as set forth in claim 2, wherein the bracket further includes a stopper, by means of which the rotation angle of the second bracket part is limited.

7. The bracket for motor vehicle rest pedal as set forth in claim 1, wherein the L-like plate structure is provided with at least one reinforce rib and/or at least one weight reduction hole.

8. The bracket for motor vehicle rest pedal as set forth in claim 3, wherein the second bracket part is of single piece structure or multi-piece structure consisting of more than one piece arranged side by side in axial direction of the pin.

9. The bracket for motor vehicle rest pedal as set forth in claim 1, wherein the structure and shape of the second bracket part match those of the pedal plate.

10. The bracket for motor vehicle rest pedal as set forth in claim 1, wherein the bracket is a bracket for co-driver motor vehicle rest pedal.

11. A motor vehicle rest pedal, wherein the rest pedal comprises a bracket as set forth in claim 1, and wherein a pedal plate is fixed on the second bracket part.
